(19) United States
(12) Patent Application Publication
(10) Pub. No.: US 2009/0067914 A1
(43) Pub. Date: Mar. 12, 2009

(54) BINDING DEVICE

(75) Inventors: Kanji Tanaka, Hyogo (JP); Hiroshi Arai, Osaka (JP); Hiroyuki Yamashita, Hyogo (JP)

Correspondence Address: OKADA;C/O KEATING & BENNETT, LLP, 1800 Alexander Bell Drive, SUITE 200, Reston, VA, 20191, US

(73) Assignee: LIHIT LAB., INC., Osaka-shi, Osaka (JP)

(21) Appl. No.: 11/577,692

(22) PCT Filed: Jan. 11, 2005
(86) PCT No.: PCT/JP05/00197

§ 371 Date: Apr. 20, 2007

(30) Foreign Application Priority Data
Oct. 22, 2004 (JP) 2004-308488

(51) Int. Cl. B42F 13/20

(52) U.S. Cl. 402/36

(57) ABSTRACT

A binding device having a binding member that operates at a binding position of objects to be bound has a structure with which the bound objects do not readily come off. The binding device includes a board having a bearing plate. A spring member and an operation lever are attached to a shaft inserted in the bearing plate and a turned-up part. Protruding pieces of a binding member are inserted in through holes of turned-up parts formed in the board. One end of the spring member is secured to the operation lever, and the other end is fitted in a through hole of a turned portion at the distal end of the binding member. By closing the operation lever, the binding member rotates around a line connecting the protruding pieces at both ends, thereby pressing down sheets of paper placed on the board with a pressing portion. At this time, the other end of the spring member presses the turned portion, thereby biasing the pressing portion.

### TECHNICAL FIELD

This invention relates to a binding device, and particular to a binding device for holding together sheets of paper or other objects and binding them into a file.

### BACKGROUND ART

FIG. 33 shows one example of a conventional binding device.

The binding device 1 includes a board 2, with a bearing plate 3 being provided upright at one widthwise side of the board 2.

An operation lever 4 is pivoted to the bearing plate 3 so that it is rotatable in a plane that is perpendicular to the board 2.

Furthermore, a pressing plate 5 is provided, which comes close to or separates from the board 2 in conjunction with the rotation of the operation lever 4.

Between the pressing plate 5 and the operation lever 4 is provided a spring member 6 for biasing the pressing plate 5 toward the board 2 when the operation lever 4 is operated.

Cranks 7 are attached on both sides of this spring member 6.

The cranks 7 are bridged between the bearing plate 3 and the pressing plate 5 so that the pressing plate 5 is substantially parallel to the board 2 when it comes close to or separates from the board 2.

The pressing plate 5 has a structure with an inverted U-shape cross section to hold down the objects to be bound such as paper with both of its widthwise ends.

With this binding device 1, by operating the operation lever 4, the pressing plate 5 displaces toward the board 2 as it moves along the bearing plate 3 so that the objects to be bound such as paper are held therebetween and secured.

However, one problem with this binding device 1 is that, since the pressing plate 5 moves along the bearing plate 3, it moves along one end of the objects to be bound such as paper, because of which it is hard to set the objects to be bound such as paper in a binding position.

To solve this problem, another binding device shown in FIG. 34 was devised.

This binding device 8 has no cranks, and the pressing plate 5 is rotatably attached to a rotation axis 9a that is connected to two arms 9.

The ends of the arms 9 are rotatably attached to the bearing plate 3, and the pressing plate 5 is attached such as to be rotatable around two axes, i.e., at the attachment part on the bearing plate 3 and around the rotation axis 9a.

With this binding device 8, by operating the operation lever 4, the pressing plate 5 rotates around the attachment parts of the arms 9 on the bearing plate 3 and around the rotation axis 9a as it is pressed toward the board 2, the pressing plate 5 being remained in parallel with the bearing plate 3.

Therefore, as the pressing plate 5 moves at the binding position of the objects to be bound such as paper, it is possible to set the objects readily at the binding position (see Patent Document 1).

There is also a binding device 12 that has a plate-like holding plate 10 rotatably supported at pivotal support parts 11 on the board 2, as shown in FIG. 35, so that objects to be bound such as paper are bound on one side of the pivotal support parts 11.

With this binding device 12, a spring member 6 is provided to bias the other side of the pivotal support parts 11 of the holding plate 10 so as to hold together the objects to be bound such as paper at one side of the pivotal support parts 11 of the holding plate 10 (see Patent Document 2).

Patent Document 1: Japanese Patent Laid-Open Publication No. Hei

Patent Document 2: Japanese Utility Model Laid-Open Publication No. Sho 49-76714

### DISCLOSURE OF THE INVENTION

### Problems to be Solved by the Invention

However, with the binding devices shown in FIG. 33 and FIG. 34, the objects to be bound such as paper are pressed with both widthwise ends of the pressing plate that has an inverted U-shape cross section, which means that the force exerted by the spring member is dispersed, causing the bound objects such as paper to readily come off.

The problem with the binding device shown in FIG. 35 is that since it has a structure in which the bound objects such as paper are held on one side of the pivotal support parts of the holding plate while the other side of the pivotal support parts is biased with the spring member, considering the size of the entire binding device that is attached to a file, the length from the pivotal support parts to the binding side is longer than that to the spring member side.

Accordingly, the force applied at the binding side of the holding plate is smaller than the biasing force applied by the spring member, because of which there is a risk that the bound objects such as paper may readily come off.

Accordingly, it is a main object of the present invention to provide a binding device having a binding member that works at a binding position of objects to be bound such as paper, the binding device having a structure with which the bound objects are hard to come off.

### Means for Solving the Problems

This invention provides a binding device including: a plate-like board; an operation lever rotatably supported on the board; a one-piece binding member formed with a pressing portion at a distal end thereof for pressing down and holding objects to be bound on the board; and a spring member coupled to the operation lever and to the distal end of the binding member such as to apply a pressure to the distal end of the binding member when the operation lever is operated, the binding member being rotatable around an axis at an opposite side from the pressing portion when the operation lever is operated.

The binding member of this binding device may be formed of a single plate material, the distal end of the plate material forming the pressing portion such that the objects to be bound are pressed down along a straight line or at a plurality of positions along a straight line.

The pressing portion may be formed by bending the distal end of the binding member towards the rotation center of the binding member.

Alternatively, the pressing portion may be formed by bending the distal end of the binding member towards the rotation center of the binding member and by bending the distal end again toward the board side.

The rotation center of the binding member may be formed by providing protruding pieces projecting from both ends of the binding member and inserting these protruding pieces into through holes formed in turned-up parts formed in the board.

Further, rotation axes of the operation lever and the binding member may either be orthogonal or parallel to each other.

Since the pressing portion is formed at the distal end of the binding member and the binding member is rotatable around the axis at the opposite side from the pressing portion, the pressing portion of the binding member is deformed at the binding position of the bound objects such as paper. Moreover, because pressure is applied by the spring member directly to the distal end of the binding member, the force from the spring member is directly applied to the bound objects, whereby the bound objects such as paper will not easily come off of the binding device.

With the binding member being formed of a single plate material, and with the pressing portion being formed such as to press down the bound objects along a straight line or at a plurality of positions along a straight line, the force from the spring member is hardly dispersed, which further ensures that the objects will not easily come off.

With the distal end of the plate-like binding member being bent towards its rotation center, when the bound objects are pulled in a direction out of the binding device, the pressing portion will resist this pulling-out direction applied to the objects, whereby the objects will not easily come off.

With the rotation center of the binding member being provided by inserting the protruding pieces projecting from the ends of the binding member into the through holes in the turned-up parts of the board, the number of components is reduced as compared to the design in which a rotation shaft is used around which the binding member is rotated, whereby the binding device can be produced at low cost.

Further, the rotation axes of the operation lever and the binding member can be freely arranged.

### EFFECTS OF THE INVENTION

This invention thus provides a binding device having a binding member that works at a binding position of objects to be bound such as paper, the binding device having a structure with which the bound objects are hard to come off.

The above and other objects, features and advantages of this invention will become more readily apparent from the following description of preferred embodiments in conjunction with the accompanying drawings.

### BRIEF DESCRIPTION OF THE DRAWINGS

FIG. 1 is a perspective view illustrating one example of the binding device of this invention;

FIG. 2 is a perspective view of the binding device of FIG. 1 in a closed state;

FIG. 3 is a side diagram of the binding device of FIG. 1 in an open state;

FIG. 4 is a side diagram of the binding device of FIG. 1 in a closed state;

FIG. 5 is an exploded perspective view of the binding device of FIG. 1;

FIG. 6 is a plan view illustrating a variation of the pressing portion of the binding device of FIG. 1;

FIG. 7 is a plan view illustrating another variation of the pressing portion of the binding device of FIG. 1;

FIG. 8 is a plan view illustrating yet another variation of the pressing portion of the binding device of FIG. 1;

FIG. 9 is a perspective view illustrating another example of the binding device of this invention;

FIG. 10 is a perspective view of the binding device of FIG. 9 in a closed state;

FIG. 11 is a side diagram of the binding device of FIG. 9 in an open state;

FIG. 12 is a side diagram of the binding device of FIG. 9 in a binding state;

FIG. 13 is a diagram illustrating the state of the pressing portion when a small amount of paper is bound with the binding device of FIG. 1;

FIG. 14 is a diagram illustrating the state of the pressing portion when a large amount of paper is bound with the binding device of FIG. 1;

FIG. 15 is a diagram illustrating the state wherein a small amount of paper is bound with a binding device having a different pressing portion;

FIG. 16 is a diagram illustrating the state wherein a large amount of paper is bound with the binding device of FIG. 12;

FIG. 17 is a diagram illustrating the state wherein a large amount of paper is bound with a binding device having a different pressing portion;

FIG. 18 is a diagram illustrating the state wherein sheets of paper are bound with a binding device having a different pressing portion;

FIG. 19A and FIG. 19B are diagrams illustrating the relationship between the width of the binding member and a difference in the binding position when the binding device is open;

FIG. 20 is a perspective view illustrating yet another example of the binding device of this invention;

FIG. 21 is a perspective view illustrating another example of the binding device of this invention;

FIG. 22 is a perspective view illustrating one example of the binding device of this invention;

FIG. 23 is a perspective view of this binding device in a closed state;

FIG. 24 is a side diagram of the binding device in an open state;

FIG. 25 is a side diagram of the binding device in a closed state;

FIG. 26 is an exploded perspective view of the binding device of FIG. 22;

FIG. 27 is a front view of the binding device;

FIG. 28 is a diagram illustrating the operating state of the binding member and the spring member of the binding device of FIG. 22;

FIG. 29A is a front cross-sectional diagram and FIG. 29B is a partial side diagram illustrating the operating state of the binding member and the spring member of the binding device of FIG. 22;

FIG. 30 is a diagram illustrating the state of the pressing portion when a small amount of paper is bound with the binding device of FIG. 22;

FIG. 31A is a front cross-sectional diagram and FIG. 31B is a partial side diagram illustrating the operating state of the binding member and the spring member of the binding device of FIG. 22;

FIG. 32 is a diagram illustrating the state of the pressing portion when a large amount of paper is bound with the binding device of FIG. 22;

FIG. 33 is a diagram illustrating one example of a conventional binding device;

FIG. 34 is a diagram illustrating another example of a conventional binding device; and

FIG. 35 is a diagram illustrating yet another example of a conventional binding device;

### DESCRIPTION OF THE REFERENCE NUMERALS

20, 220 binding device
22, 222 board
24, 224 bearing plate
26, 226 through hole
28, 228 retainer projection
30, 34, 38, 230, 234, 238 turned-up part
32, 36, 40, 232, 236, 240 through hole
42 projection
44 through hole
46, 246 shaft
50, 250 spring member
50a, 250a coil part
50b, 250b one end
50c, 250c the other end
50d, 250d upright portion
50e, 250e bridge portion
50f, 250f engaging portion
60, 260 operation lever
62, 262 through hole
64, 264 bent portion
66, 266 through hole
70, 270 binding member
270a standing portion
270b bridge portion
270c bent portion
72, 272 protruding piece
74, 274 turned portion
76, 276 pressing portion
78, 278 through hole
80, 280 rib
90 paper jogging part
100 bound objects

### BEST MODE FOR CARRYING OUT THE INVENTION

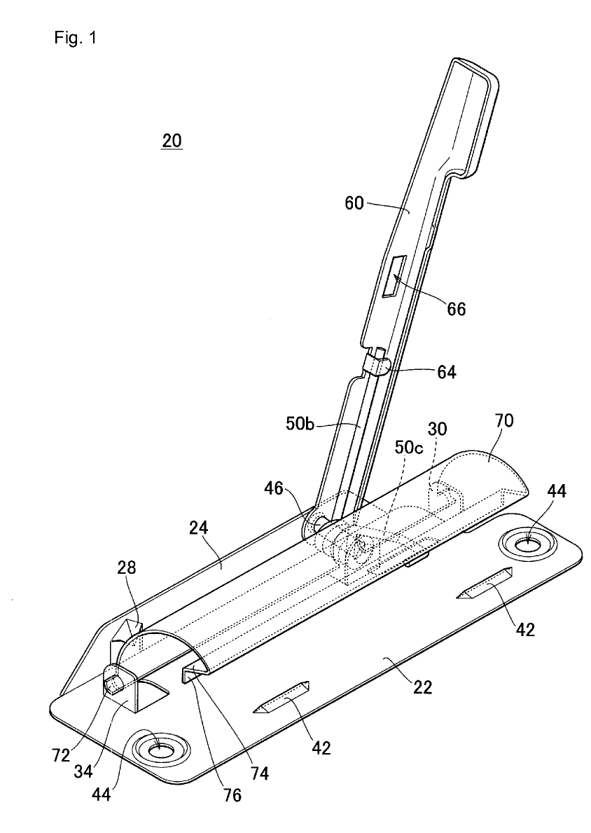

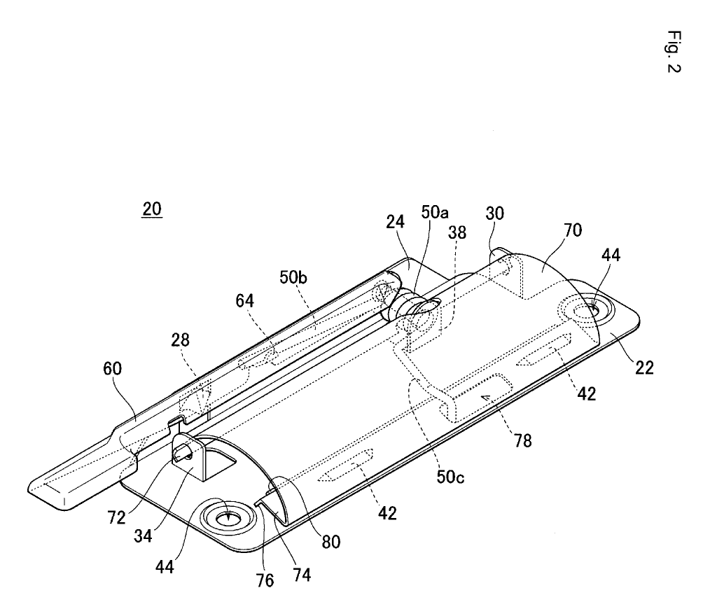

FIG. 1 is a perspective view illustrating one example of the binding device of this invention, and FIG. 2 is a perspective view of this binding device in a closed state.

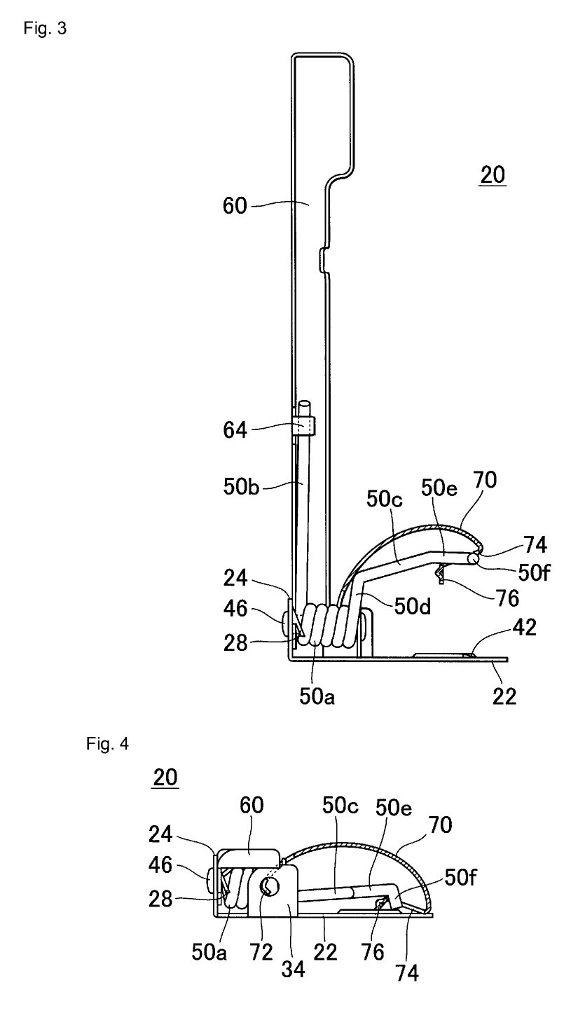

FIG. 3 is a side diagram of the binding device in an open state, and FIG. 4 is a side diagram of the binding device in a closed state.

The binding device 20 includes a board 22 made of a thin metal plate.

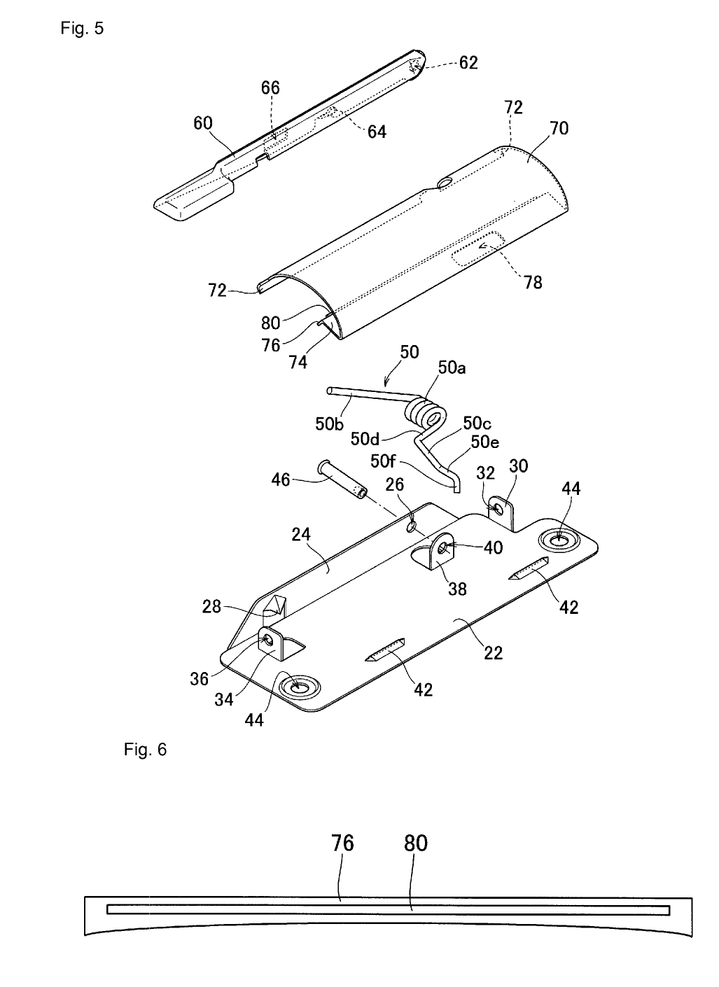

Along the straight lengthwise edge at one widthwise end of the board 22 is integrally formed a bearing plate 24 that is upright relative to the board 22, as shown in FIG. 5.

The bearing plate 24 is continuous from the front end edge to the vicinity of the rear end edge along the length of the board 22.

At one lengthwise end (rear end) of the bearing plate 24 is formed a circular through hole 26, and at the other lengthwise end (front end) of the bearing plate 24 is formed a retainer projection 28 for retaining an operation lever that will be described later.

The retainer projection 28 is formed by, for example, providing a quadrangle aperture in the bearing plate 24 and pressing out an upper part of the aperture towards the board 22.

Near the rear end of the bearing plate 24 where the through hole 26 is provided, at a suitable distance from the bearing plate 24, one corner at one lengthwise end of the board 22 is cut and turned up to form a turned-up part 30.

The main surface of the turned-up part 30 is orthogonal to the main surface of the bearing plate 24.

This turned-up part 30 is formed with a circular through hole 32.

Furthermore, another turned-up part 34 having a surface that is parallel to the main surface of the turned-up part 30 is formed near the front end where the retainer projection 28 is provided.

The turned-up part 34 is provided by forming a U-shape cut in the board 22 and turning up this part.

This turned-up part 34 is formed with a circular through hole 36.

These turned-up parts 30 and 34 are opposite each other such that a line connecting their through holes 32 and 36 is parallel to the main surface of the bearing plate 24 on the side of the board 22.

Between these turned-up parts 30 and 34 and on the side away from the bearing plate 24 relative to the line connecting the through holes 32 and 36 of the turned-up parts 30 and 34 is formed a turned-up part 38 having a surface that is parallel to the surface of the bearing plate 24.

This turned-up part 38, too, is provided by forming a U-shape cut in the board 22 and turning up this part.

This turned-up part 38 is formed with a circular through hole 40 and positioned such that its through hole 40 is opposite the through hole 26 of the bearing plate 24.

That is, it is formed so that the line connecting the through holes 32 and 36 of the turned-up parts 30 and 34 is orthogonal to the line connecting the through holes 26 and 40 of the bearing plate 24 and the turned-up part 38.

At the other widthwise end of the board 22 are formed two projections 42.

These projections 42 are formed side by side and spaced from each other in the lengthwise direction of the board 22.

Furthermore, a pair of through holes 44 are formed at both lengthwise ends of the board 22, one each at the front end and at the rear end, for attaching the binding device 20 to a file or the like.

A shaft 46 is inserted in the through hole 26 of the bearing plate 24 and in the through hole 40 of the turned-up part 38, and a spring member 50 consisting of a torsion coil spring and the operation lever 60 are attached to the shaft 46.

The spring member 50 is formed to include a coil part 50a, one end 50b of the coil part 50a extending substantially parallel to the surface of the bearing plate 24, and the other end 50c of the coil part 50a extending in the widthwise direction of the board 22 toward a direction away from the bearing plate 24.

The operation lever 60 is made of a metal plate or the like and has an elongated shape with a substantially L-shaped or U-shaped cross section to increase its strength.

A circular through hole 62 is formed in the vertical side wall at one lengthwise end of the operation lever 60.

The shaft 46 is attached to the bearing plate 24 and to the turned-up part 38 such that it is inserted in the through hole 62 of the operation lever 60 and in the coil part 50a of the spring member 50.

One end 50b of the spring member 50 is arranged to run along the inside of the operation lever 60 and secured with a bent portion 64 that is formed by inwardly bending part of the vertical side wall of the operation lever 60.

Furthermore, a rectangular through hole 66 is formed in the vertical wall of the operation lever 60 at the position corresponding to the retainer projection 28 of the bearing plate 24.

The retainer projection 28 is fitted in this through hole 66 to secure the operation lever 60 to the bearing plate 24.

Furthermore, the other lengthwise end of the operation lever 60 is formed wide to allow easy operation with a finger.

Furthermore, a binding member 70 that is substantially rectangular in top view is attached on the board 22 such as to extend along the length of the board 22 and parallel to the bearing plate 24.

The binding member 70 is formed of, for example, a single metal plate.

The binding member 70 has a length that is substantially equal to the distance between, for example, the turned-up parts 30 and 34, and is formed to have a widthwise curved, upwardly bulging shape (semi-circular cross section).

On the bearing plate 24 side of the width of the binding member 70, protruding pieces 72 or pivotal axes are formed such as to protrude from the lengthwise ends.

These protruding pieces 72 are fitted in the through holes 32 and 36 of the turned-up parts 30 and 34, which serve as bearings.

Therefore, the binding member 70 is rotatable around the line connecting the two protruding pieces 72.

To increase the strength of the protruding pieces 72 and to facilitate rotation of the protruding pieces 72 inside the through holes 32 and 36, the protruding pieces 72 are warped in the widthwise direction.

Thus, the protruding pieces 72 protruding from the binding member 70 are fitted in the through holes 32 and 36 of the turned-up parts 30 and 34, whereby the number of components is reduced as compared to the design in which a separate part such as a rotation shaft is used to hold the binding member 70 rotatably.

The opposite side from the bearing plate 24 of the width of the binding member 70 is turned toward the above-described rotation center (protruding pieces 72 side) to form a turned portion 74.

The turned portion 74 is continuous from the front end edge to the rear end edge of the binding member 70.

Furthermore, the distal end of the turned portion 74 is turned toward the board 22 to form a pressing portion 76 which is for pressing objects to be bound 100 such as paper.

The pressing portion 76 is continuous from the front end edge to the rear end edge of the turned portion 74.

The pressing portion 76 is formed to incline toward the rotation center of the binding member 70 from the turned portion 74 to the board 22 when the binding member 70 is closed on the board 22.

Therefore, the turned portion 74 and the pressing portion 76 are continuous in a substantially L-shaped manner.

This pressing portion 76 presses the bound objects 100 such as paper along one straight line.

Note, when the binding member 70 is closed on the board 22, the turned portion 74 is inclined upward from one end of the binding member 70 to the inside of the binding member 70.

One end 50b of the spring member 50 extends linearly from the rear upper end on the bearing plate 24 side of the coil part 50a to the front, and is formed such that, when no force is applied to its distal end, the distal end extends diagonally upwards toward the front.

The other end 50c is substantially L-shaped, extending from the front lower end on the side of the turned-up part 38 of the coil part 50a toward the opposite side from the bearing plate 24, and when no force is applied, its upright portion 50d extends upwards and a bridge portion 50e extends diagonally upwards from the upper end of the upright portion 50d, and a projecting engaging portion 50f is turned horizontally from the free end of the bridge portion 50e.

The turned portion 74 is formed with a rectangular through hole 78, and the other end 50c of the spring member 50 is fitted therein from above, the distal end of the other end 50c of the spring member 50 being bent so that it does not come off of the through hole 78.

In this embodiment, the through hole 78 is formed at a position closer to the coil part 50a coiled around the shaft 46, between the protruding pieces 72 at the front and rear ends of the binding member 70.

Furthermore, the pressing portion 76 is formed with a linear rib 80 to prevent deformation caused by the force applied to press down the objects to be bound 100 such as paper.

The distal end of the spring member 50 (engaging portion 50f) remains substantially in the same position in the widthwise direction of the board 22 whether the binding member 70 is closed or opened as shown in FIG. 3 and FIG. 4.

When the operation lever 60 is locked in the retainer projection 28, with the binding member 70 pressing down the objects to be bound 100 such as paper, the other end 50c of the spring member 50, which is initially bent, is stretched, as well as the distal end (engaging portion 50f) is twisted so that the engaging portion 50f is deformed downwards from its initial horizontal position. The through hole 78 extends along the length and the width of the turned portion 74 so as to allow this deformation of the spring member 50.

The portion pressed down by the pressing portion 76 needs not be one straight line but instead, as shown in FIG. 6, it may be pressed with both lengthwise ends of the pressing portion 76.

In this case, the edge of the pressing portion 76 is slightly warped inwards from the lengthwise ends to the center.

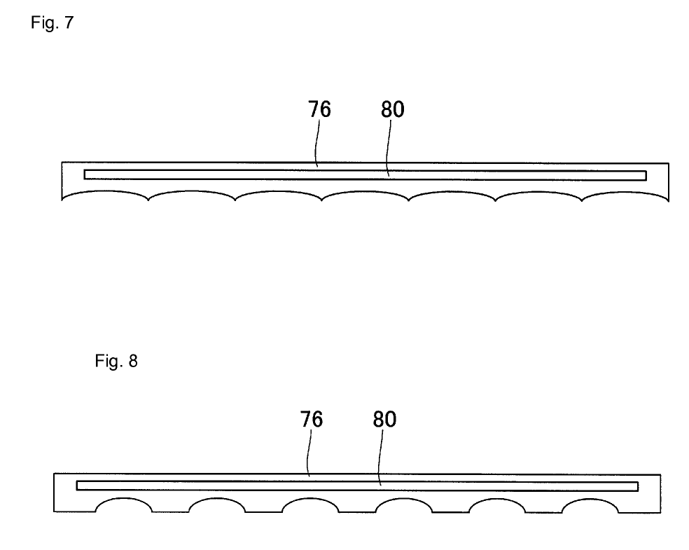

Also, as shown in FIG. 7, a plurality of dents may be formed along the length of the pressing portion 76 so as to press down the objects to be bound 100 such as paper at a plurality of points along a straight line.

Furthermore, the objects to be bound 100 such as paper can be pressed at a plurality of positions along a straight line as shown in FIG. 8, in this case not at points but linearly.

In other words, the portion pressed with the pressing portion 76 may either be a single straight line, or a plurality of points or lines along a straight line.

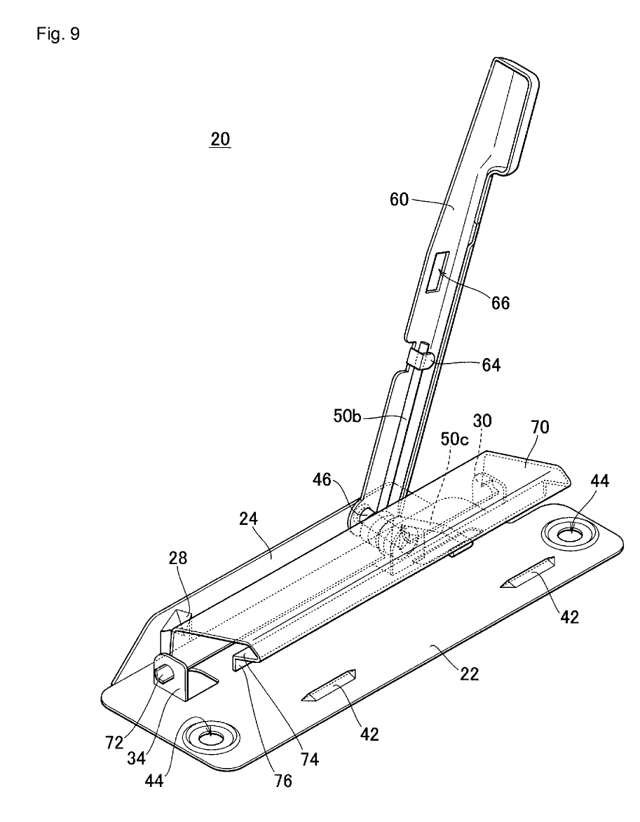

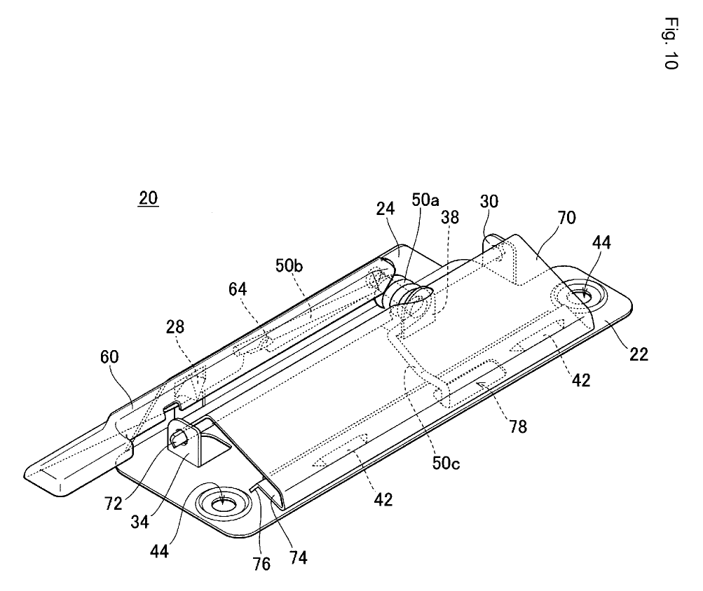

The binding member 70 may be formed by bending a metal plate as shown in FIG. 9 or FIG. 12 instead of the warped shape.

This binding device 20 is attached to a file or the like using, for example, fixture metal parts inserted in the through holes 44 in the board 22.

The binding member 70 is opened and closed by operating the operation lever 60.

Referring now to FIG. 1, when the operation lever 60 is turned up, the other end 50c of the spring member 50 lifts up the binding member 70, creating a gap between the board 22 and the pressing portion 76 of the binding member 70.

Objects to be bound 100 such as paper are inserted in this gap, and the operation lever 60 is turned down to close the binding member 70 so that the objects to be bound 100 such as paper are pressed down onto the board 22 with the pressing portion 76.

That is, turning down the operation lever 60 tightens up the coil part 50a of the spring member 50, whereby the other end 50c of the spring member 50 biases the pressing portion 76 toward the board 22.

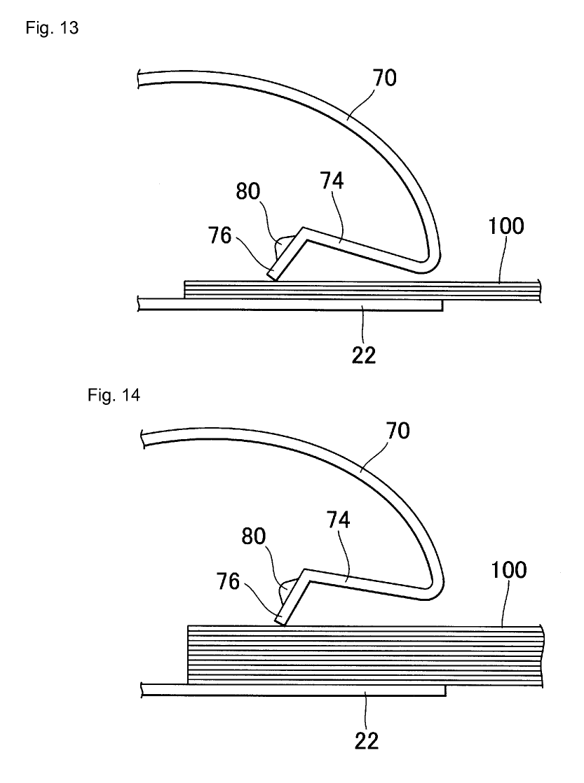

Here, as shown in FIG. 13, the pressing portion 76 is pressed diagonally against the bound objects 100 such as paper.

When a force is applied that causes the bound objects 100 such as paper to be pulled out, there will be a force applied oppositely from the inclined direction of the pressing portion 76 as well as a force that causes the bent portion of the turned portion 74 and the pressing portion 76 to bend further.

The restoring force caused by the deformation of the turned portion 74 and the pressing portion 76 creates a resisting force against the pulling-out of the bound objects 100 such as paper from the pressing portion 76, whereby the bound objects 100 such as paper are hard to come off of the binding device 20.

Moreover, because the pressing portion 76 is inclined toward the rotation center of the binding member 70 from the turned portion 74 to the board 22, as shown in FIG. 14, when the objects to be bound 100 such as paper are thick, the pressing portion 76, while it is more upright than when the objects 100 are thin, hardly comes to a position where it is orthogonal to the surface of the bound objects 100 such as paper, so that the resisting force against the coming-off of the bound objects 100 such as paper is well retained.

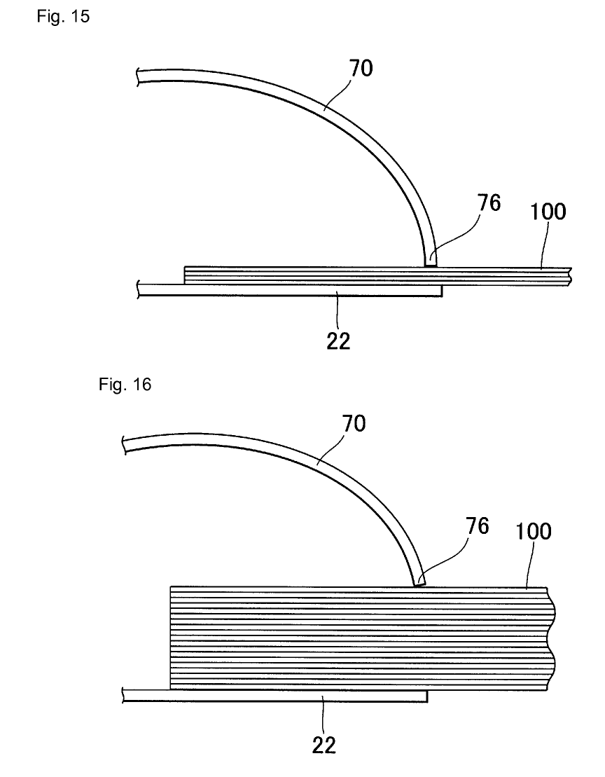

The shape of the pressing portion 76 is not limited to the one that is formed by turning the end of the binding member 70; as shown in FIG. 15, the distal end of the warped plate-like binding member 70 may serve as the pressing portion 76.

In this case, the binding member 70 should preferably have a semi-circular cross section so that the pressing portion 76 makes contact with the surface of the objects to be bound 100 such as paper at more or less the same angle irrespective of the thickness of the objects 100, as shown in FIG. 16.

In this way, the entire binding member 70 can serve to resist the force that is applied in the pulling-out direction of the bound objects 100 such as paper, whereby the objects 100 are hard to come off.

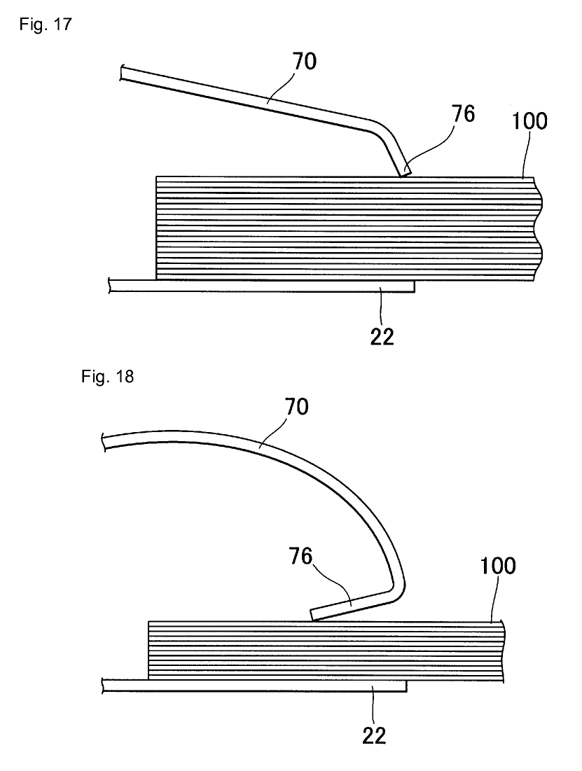

In contrast, if the binding member 70 were bent to have a rectangular cross section, when the objects to be bound 100 such as paper are thick, the pressing portion 76 would be inclined along the pulling-out direction of the objects 100 as shown in FIG. 17, because of which it would have a low resisting force against the force that acts in the pulling-out direction of the objects 100 and the objects 100 would easily come off.

Therefore, when the distal end of the binding member 70 is not bent but to serve as the pressing portion 76 as it is, the binding member 70 should preferably have a semi-circular or curved cross section.

If the pressing portion 76 is made by bending the binding member 70, it may be formed by bending the distal end of the binding member 70 only once toward the rotation center, as shown in FIG. 18.

In this case, no turned portion 74 is formed, but when a force is applied that causes the bound objects 100 such as paper to be pulled out, there will be a force that acts in an opposite direction from the inclined direction of the pressing portion 76, whereby the pressing portion 76 deforms such as to stand up.

Therefore, the restoring force caused by the deformation of the pressing portion 76 creates a resisting force against the pulling-out of the bound objects 100 such as paper.

It should be noted here that in the binding device 20 having any of the pressing portions 76 shown in FIG. 15, FIG. 17, or FIG. 18, the portion pressed with the pressing portion 76 may either be one straight line or a plurality of points or lines along a straight line, as shown in from FIG. 6 to FIG. 8.

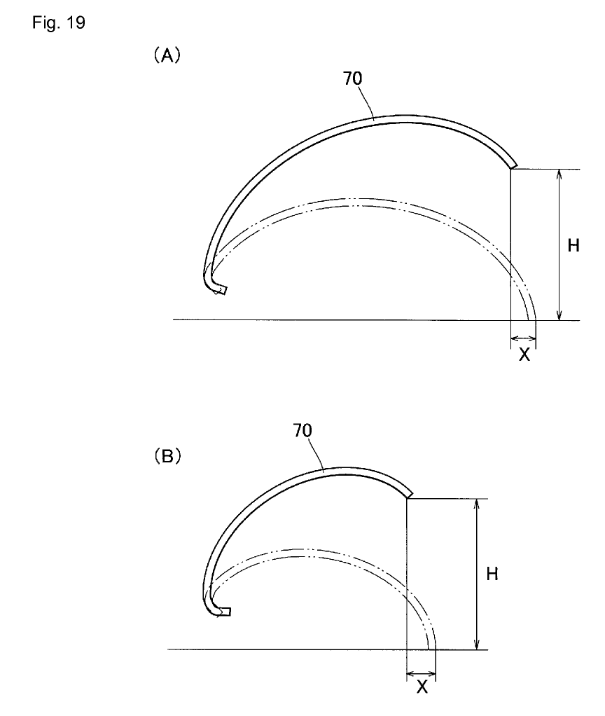

When, as shown in FIG. 19A and FIG. 19B, the height H of the pressing portion 76 from the board 22 is the same when the binding member 70 is open, the larger the width of the binding member 70 is, the smaller the difference X is between the open position and the closed position of the pressing portion 76 to the surface of the board 22.

Therefore, when binding the objects 100 such as paper, there is less misalignment between the position of the pressing portion 76 when the binding member 70 is open and the binding position of the bound objects 100 such as paper, whereby the binding of the objects 100 such as paper is made easy.

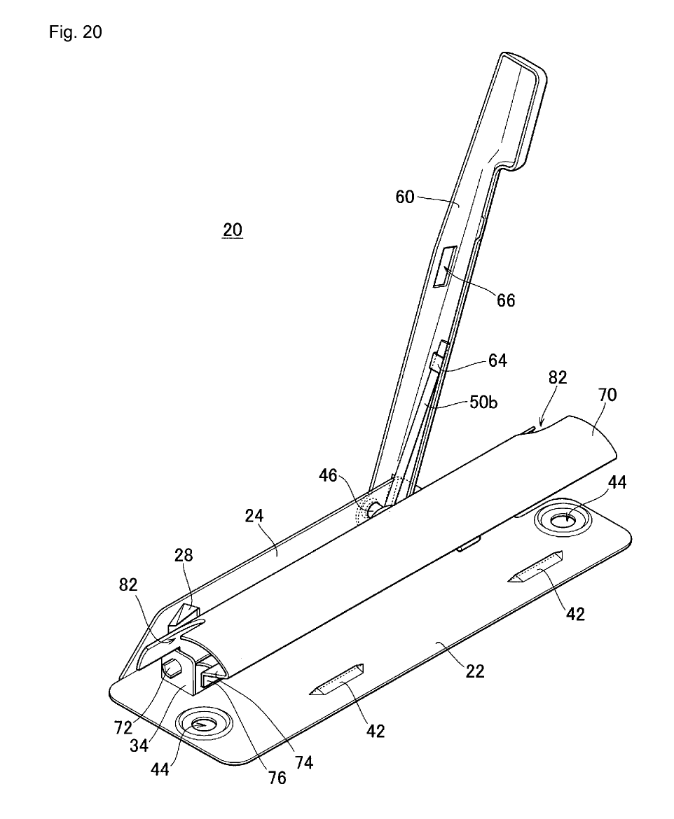

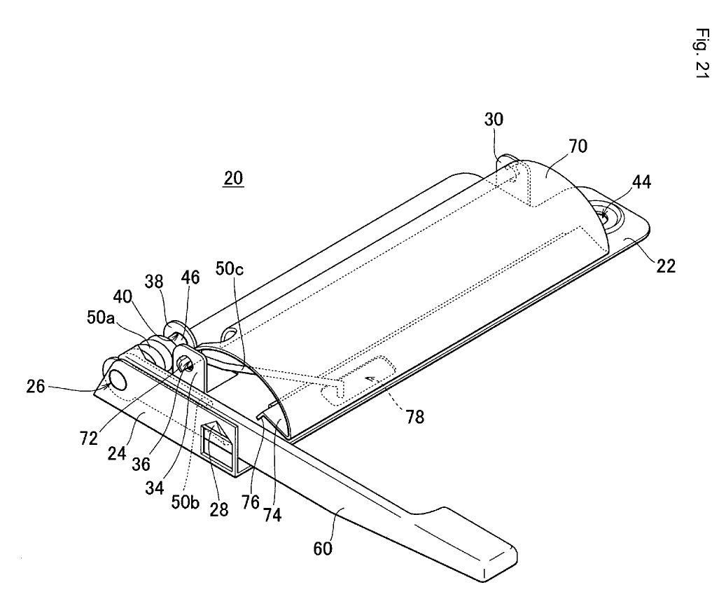

To make the width of the binding member 70 larger, as shown in FIG. 20, the vertical side wall of the operation lever 60 may be arranged on the outer side of the bearing plate 24.

This way, with the retainer projection 28 being formed to protrude outwardly from the bearing plate 24, the operation lever 60 is displaced to the outer side of the bearing plate 24 to open the binding member 70.

Therefore, the operation lever 60 need not be displaced toward the binding member 70, and the binding member 70 can be brought closer to the bearing plate 24, i.e., the width of the binding member 70 can be made larger.

Note, in FIG. 20, the binding member 70 is formed with notches 82 at both lengthwise ends, and the through holes 44 are formed in the board 22 at the positions corresponding to the notches 82.

Accordingly, the binding device 20 can be attached to a file using fixture metal parts or the like inserted into the through holes 44 through the notches 82.

Furthermore, as shown in FIG. 21, it is possible to arrange the rotation direction of the operation lever 60 to be the same as that of the binding member 70.

In this binding device 20, the bearing plate 24 is provided at one lengthwise end of the board 22.

The shaft 46 is inserted into the through hole 26 in the bearing plate 24 to extend along the length of the board 22.

The coil part 50a of the spring member 50 and the operation lever 60 are attached to this shaft 46.

One end 50b of the spring member 50 extends along the width of the board 22 and secured to the operation lever 60.

The other end 50c of the spring member 50 extends along the width of the board 22 and fits in the through hole 78 formed in the turned portion 74 of the binding member 70.

This binding device 20 is used, for example, to bind one lengthwise end of the objects 100 to be bound such as paper.

In this case, the binding device 20 is arranged at one widthwise end of the objects 100 to be bound such as paper, with the operation lever 60 being arranged on the outer side of the objects 100.

In other words, this binding device 20 includes the board 22 formed of a thin metal plate.

A bearing plate 24, which is upright relative to the board 22, is integrally formed along the straight left side edge at one lengthwise end of the board 22.

The bearing plate 24 is continuous from the front end edge to the vicinity of the rear end edge of the width of the board 22.

At one lengthwise end (rear end) of the bearing plate 24 is formed a circular through hole 26, and at the other lengthwise end (front end) of the bearing plate 24 is formed a retainer projection 28 for retaining the operation lever 60.

The retainer projection 28 is formed by, for example, providing a quadrangle aperture in the bearing plate 24 and pressing out an upper part of the aperture towards the board 22.

Near the through hole 26 of the bearing plate 24, at a suitable distance from the bearing plate 24, one lengthwise end of the board 22 is cut and turned up to form a turned-up part 34.

The main surface of the turned-up part 34 is parallel to the main surface of the bearing plate 24.

This turned-up part 34 is formed with a circular through hole 36.

Furthermore, near the right end of the board 22 is formed another turned-up part 30 that has a surface parallel to the main surface of the turned-up part 34.

The turned-up part 30 is provided by cutting and turning up part of the edge of the board 22.

This turned-up part 30 is formed with a circular through hole 32.

These turned-up parts 30 and 34 are arranged so that a line connecting their through holes 32 and 36 is orthogonal to the main surface of the bearing plate 24 on the side of the board 22.

Between these turned-up parts 30 and 34 is formed a turned-up part 38 that has a surface parallel to the surface of the bearing plate 24.

This turned-up part 38, too, is provided by forming a U-shape cut in the board 22 and turning up this part.

This turned-up part 38 is formed with a circular through hole 40 and positioned such that its through hole 40 is opposite the through hole 26 of the bearing plate 24.

That is, it is formed so that the line connecting the through holes 32 and 36 of the turned-up parts 30 and 34 is parallel to the line connecting the through holes 26 and 40 of the bearing plate 24 and the turned-up part 38.

Through holes 44 for attaching the binding device 20 to a file or the like are provided at both lengthwise ends of the board 22.

A shaft 46 is inserted in the through hole 26 of the bearing plate 24 and in the through hole 40 of the turned-up part 38, and a spring member 50 consisting of a torsion coil spring and the operation lever 60 are attached to the shaft 46.

The spring member 50 is formed to include a coil part 50a, one end 50b of the coil part 50a extending substantially parallel to the surface of the bearing plate 24, and the other end 50c of the coil part 50a extending in the widthwise direction of the board 22 toward a direction away from the bearing plate 24.

The operation lever 60 is made of a metal plate or the like and has an elongated shape with a substantially L-shaped or U-shaped cross section to increase its strength.

A circular through hole 62 is formed in the vertical side wall at one lengthwise end of the operation lever 60.

The shaft 46 is attached to the bearing plate 24 and the turned-up part 38 such that it is inserted in the through hole 62 of the operation lever 60 and in the coil part 50a of the spring member 50.

One end 50b of the spring member 50 is arranged to run along the inside of the operation lever 60 and secured with a bent portion 64 that is formed by inwardly bending part of the vertical side wall of the operation lever 60.

Furthermore, a rectangular through hole 66 is formed in the side wall of the operation lever 60 at the position corresponding to the retainer projection 28 of the bearing plate 24.

The retainer projection 28 is fitted in this through hole 66 to secure the operation lever 60 to the bearing plate 24.

Furthermore, the other end in the lengthwise direction of the operation lever 60 is formed wide to allow easy operation with a finger.

Furthermore, a binding member 70 that is substantially rectangular in top view is attached on the board 22 such as to extend along the length of the board 22 so that the length of the binding member 70 is orthogonal to the length of the bearing plate 24.

The binding member 70 is formed of, for example, a single metal plate.

The binding member 70 has a length that is substantially equal to the distance between, for example, the turned-up parts 30 and 34, and is formed to have a widthwise curved, upwardly bulging shape (semi-circular cross section).

On the shaft 46 side of the width of the binding member 70, protruding pieces 72 are formed such as to protrude from the lengthwise ends.

These protruding pieces 72 are fitted in the through holes 32 and 36 of the turned-up parts 30 and 34.

Therefore, the binding member 70 is rotatable around the line connecting the two protruding pieces 72.

To increase the strength of the protruding pieces 72 and to facilitate rotation of the protruding pieces 72 inside the through holes 32 and 36, the protruding pieces 72 are warped in the widthwise direction.

Thus, the protruding pieces 72 protruding from the binding member 70 are fitted in the through holes 32 and 36 of the turned-up parts 30 and 34, whereby the number of components is reduced as compared to the design in which a rotation shaft or the like is used to hold the binding member 70 rotatably.

The opposite side from the shaft 46 of the width of the binding member 70 is turned toward the above-described rotation center to form a turned portion 74.

The turned portion 74 is continuous from the front end edge to the rear end edge of the binding member 70.

Furthermore, the distal end of the turned portion 74 is turned toward the board 22 to form a pressing portion 76 which is for pressing objects to be bound 100 such as paper.

The pressing portion 76 is continuous from the front end edge to the rear end edge of the turned portion 74.

The pressing portion 76, when the binding member 70 is closed on the board 22, is formed to incline toward the rotation center of the binding member 70 from the turned portion 74 to the board 22.

Therefore, the turned portion 74 and the pressing portion 76 are continuous in a substantially L-shaped manner.

This pressing portion 76 presses the objects to be bound 100 such as paper along one straight line.

Note, when the binding member 70 is closed on the board 22, the turned portion 74 is inclined upward from one end of the binding member 70 to the inside of the binding member 70.

While the end 50c of the spring member 50 that is secured to the binding member 70 is provided at a position near the bearing plate 24 in the previous embodiment, the end 50c of the spring member 50 may be secured to the binding member 70 near the center of the length of the turned portion 74 so that the force will be applied entirely along the length of the pressing portion 76.

Thus, in one embodiment of the binding device 20 of this invention, the binding member 70 works at the binding position of the objects 100 to be bound such as paper, whereby the paper can be held precisely at a desired position.

Furthermore, as the spring member applies a force to the vicinity of the pressing portion 76 that is at the distal end of the binding member 70, the force is efficiently applied to the pressing portion 76 when the operation lever 60 is operated, and the bound objects 100 such as paper will not easily come off.

This invention is not limited to the foregoing embodiments and it can be modified in various different ways within the concept of the invention.

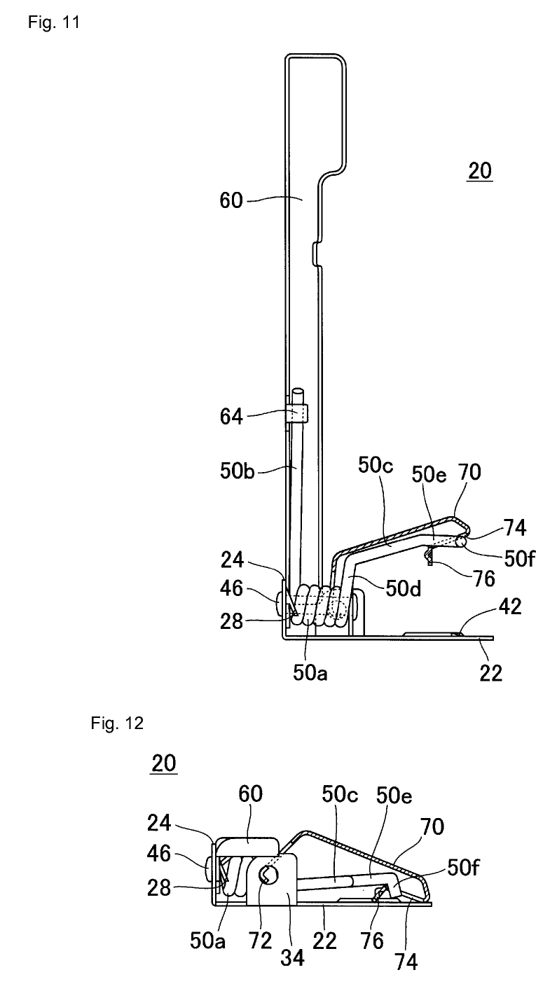

Next, examples of modification of the embodiments shown in from FIG. 9 to FIG. 12 will be described.

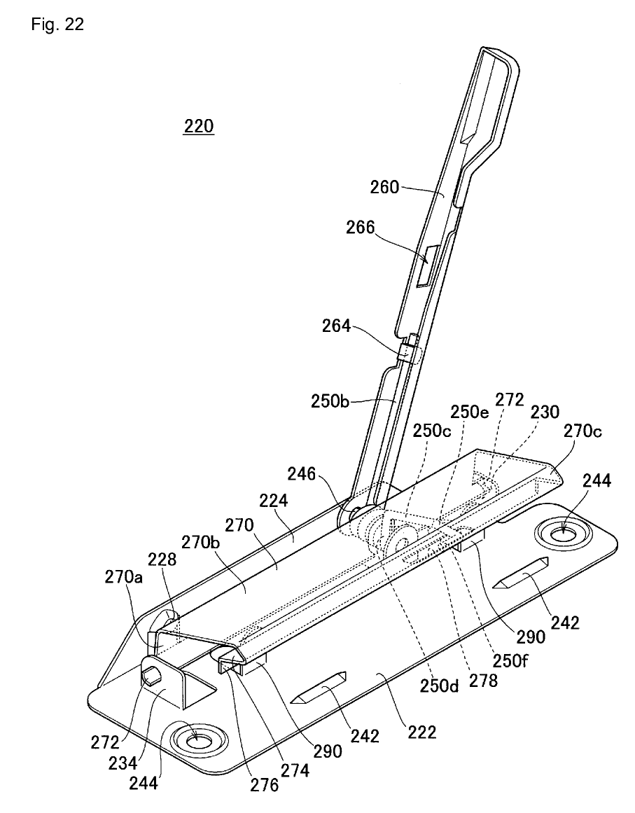

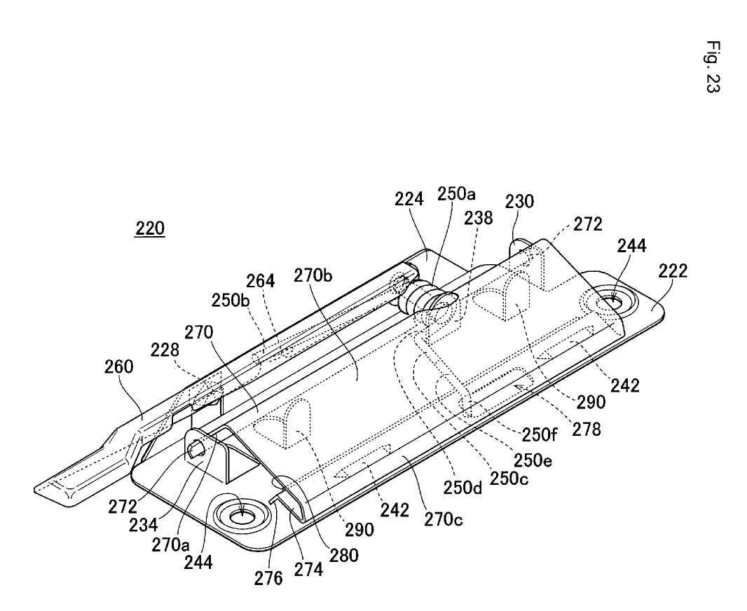

FIG. 22 is a perspective view illustrating one example of the binding device of this invention, and FIG. 23 is a perspective view of this binding device in a closed state.

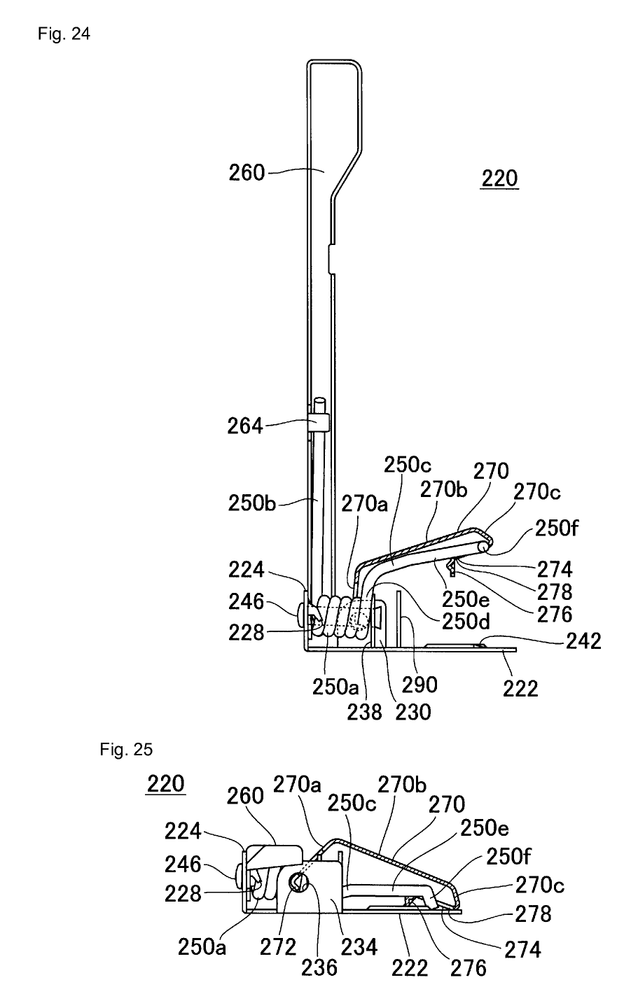

FIG. 24 is a side diagram of the binding device in an open state, and FIG. 25 is a side diagram of the binding device in a closed state.

The binding device 220 includes a board 222 made of a thin metal plate.

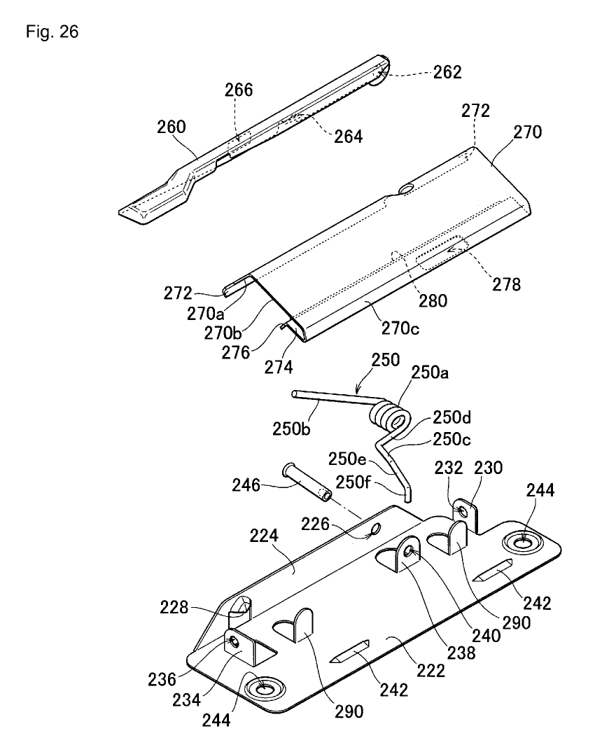

Along the straight lengthwise edge on one side of the width of the board 222 is integrally formed a bearing plate 224 that is upright relative to the board 222, as shown in FIG. 26.

The bearing plate 224 is continuous from the front end edge to the vicinity of the rear end edge along the length of the board 222.

At one lengthwise end (rear end) of the bearing plate 224 is formed a circular through hole 226, and at the other lengthwise end (front end) of the bearing plate 224 is formed a retainer projection 228 for retaining an operation lever that will be described later.

The retainer projection 228 is formed by, for example, providing a quadrangle aperture in the bearing plate 224 and pressing out an upper part of the aperture towards the board 222.

Near the rear end of the bearing plate 224 where the through hole 226 is provided, at a suitable distance from the bearing plate 224, one corner at one lengthwise end of the board 222 is cut and turned up to form a turned-up part 230.

The main surface of the turned-up part 230 is orthogonal to the main surface of the bearing plate 224.

This turned-up part 230 is formed with a circular through hole 232.

Furthermore, another turned-up part 234 that has a surface parallel to the main surface of the turned-up part 230 is formed near the front end where the retainer projection 228 is provided.

The turned-up part 234 is provided by forming a U-shape cut in the board 222 and turning up this part.

This turned-up part 234 is formed with a circular through hole 236.

These turned-up parts 230 and 234 are opposite each other such that a line connecting their through holes 232 and 236 is parallel to the main surface of the bearing plate 224 on the side of the board 222.

Between these turned-up parts 230 and 234 and on the side away from the bearing plate 224 relative to the line connecting the through holes 232 and 236 of the turned-up parts 230 and 234 is formed a turned-up part 238 that has a surface parallel to the surface of the bearing plate 224.

This turned-up part 238, too, is provided by forming a U-shape cut in the board 222 and turning up this part.

This turned-up part 238 is formed with a circular through hole 240 and positioned such that its through hole 240 is opposite the through hole 226 of the bearing plate 224.

That is, it is formed so that the line connecting the through holes 232 and 236 of the turned-up parts 230 and 234 is orthogonal to the line connecting the through holes 226 and 240 of the bearing plate 224 and the turned-up part 238.

At the other widthwise end of the board 222 are formed two projections 242.

These projections 242 are formed side by side and spaced from each other in the lengthwise direction of the board 222.

Furthermore, a pair of through holes 244 are formed at both lengthwise ends of the board 222, one each at the front end and at the rear end, for attaching the binding device 220 to a file or the like.

A shaft 246 is inserted in the through hole 226 of the bearing plate 224 and in the through hole 240 of the turned-up part 238, and a spring member 250 consisting of a torsion coil spring and the operation lever 260 are attached to the shaft 246.

The spring member 250 is formed to include a coil part 250a, one end 250b of the coil part 250a extending substantially parallel to the surface of the bearing plate 224, and the other end 250c of the coil part 250a extending in the widthwise direction of the board 222 toward a direction away from the bearing plate 224.

One end 250b of the spring member 250 extends linearly from the rear upper end on the bearing plate 224 side of the coil part 250a to the front, and is formed such that, when no force is applied to its distal end, the distal end extends diagonally upwards toward the front.

The other end 250c is substantially L-shaped, extending from the front lower end on the side of the turned-up part 238 of the coil part 250a toward the opposite side from the bearing plate 224, and when no force is applied, its upright portion 250d extends upwards and a bridge portion 250e extends diagonally upwards from the upper end of the upright portion 250d, and a projecting engaging portion 250f is turned horizontally from the free end of the bridge portion 250e.

The operation lever 260 is made of a metal plate or the like and has an elongated shape with a substantially L-shaped or U-shaped cross section to increase its strength.

A circular through hole 262 is formed in the vertical side wall at one lengthwise end of the operation lever 260.

The shaft 246 is attached to the bearing plate 224 and the turned-up part 238 such that it is inserted in the through hole 262 of the operation lever 260 and in the coil part 250a of the spring member 250.

One end 250b of the spring member 250 is arranged to run along the inside of the operation lever 260 and secured with a bent portion 264 that is formed by inwardly bending part of the vertical side wall of the operation lever 260.

Further, a rectangular through hole 266 is formed in the vertical wall of the operation lever 260 at the position corresponding to the retainer projection 228 of the bearing plate 224.

The retainer projection 228 is fitted in this through hole 266 to secure the operation lever 260 to the bearing plate 224.

Further, the other lengthwise end of the operation lever 260 is formed wide to allow easy operation with a finger.

Furthermore, a binding member 270 that is substantially rectangular in top view is attached on the board 222 such as to extend along the length of the board 222 and parallel to the bearing plate 224.

The binding member 270 is formed of, for example, a single metal plate.

The binding member 270 has a length that is substantially equal to the distance between, for example, the turned-up parts 230 and 234, and is formed to have a widthwise bent, upwardly bulging shape (substantially L-shape cross section).

On the bearing plate 224 side of the width of the binding member 270, protruding pieces 272 or pivotal axes are formed such as to protrude from the lengthwise ends.

These protruding pieces 272 are fitted in the through holes 232 and 236 of the turned-up parts 230 and 234, which serve as bearings.

Therefore, the binding member 270 is rotatable around the line connecting the two protruding pieces 272.

To increase the strength of the protruding pieces 272 and to facilitate rotation of the protruding pieces 272 inside the through holes 232 and 236, the protruding pieces 272 are warped in the widthwise direction.

Thus, the protruding pieces 272 protruding from the binding member 270 are fitted in the through holes 232 and 236 of the turned-up parts 230 and 234, whereby the number of components is reduced as compared to the design in which a separate part such as a rotation shaft is used to hold the binding member 270 rotatably.

The opposite side from the bearing plate 224 of the width of the binding member 270 is turned at about 20° relative to the horizontal plane toward the above-described rotation center (protruding pieces 272 side) to form a turned portion 274.

The turned portion 274 is continuous from the front end edge to the rear end edge of the binding member 270.

Furthermore, the distal end of the turned portion 274 is turned toward the board 222 to form a pressing portion 276 which is for pressing objects to be bound 100 such as paper.

The pressing portion 276 is continuous from the front end edge to the rear end edge of the turned portion 274.

The pressing portion 276 is formed to incline toward the rotation center of the binding member 270 from the turned portion 274 to the board 222 when the binding member 270 is closed on the board 222.

Therefore, the turned portion 274 and the pressing portion 276 are continuous in a substantially L-shaped manner.

This pressing portion 276 presses the bound objects 100 such as paper along one straight line.

Note, when the binding member 270 is closed on the board 222, the turned portion 274 is inclined upward from one end of the binding member 270 to the inside of the binding member 270.

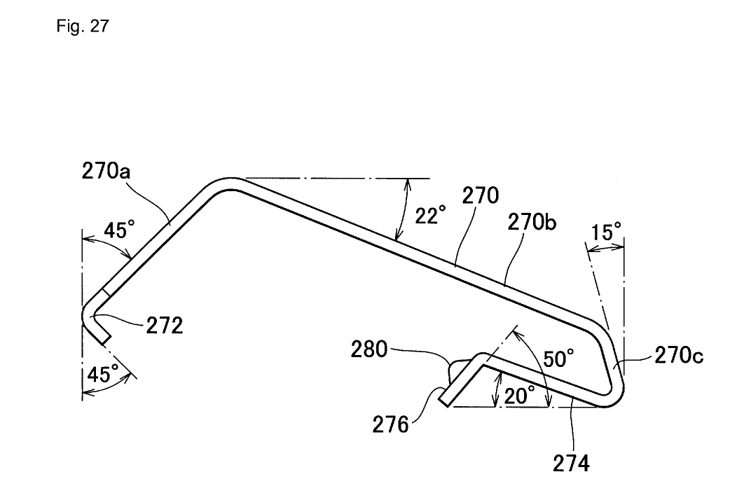

The binding member 270 includes, as shown in FIG. 27, a standing portion 270a extending diagonally upwards from the side of the protruding pieces 272 towards the opposite side from the bearing plate 224, a bridge portion 270b extending diagonally (at about 22° relative to the horizontal plane) downwards from the top end of the standing portion 270a, a turned portion 274 formed at the free end of the bridge portion 270b, and a pressing portion 276, all of these standing portion 270a, bridge portion 270b, turned portion 274, and pressing portion 276 being formed in one piece.

At the free end of the bridge portion 270b is formed a bent portion 270c by bending the free end diagonally (at about 15° relative to the vertical plane) downwards, from the front end edge to the rear end edge of the binding member 270.

The turned portion 274 is continuously formed to the free end of the bent portion 270c, the turned portion 274 being spaced from and substantially parallel to the bridge portion 270b, so that it is slightly bent towards the bridge portion 270b when the pressing portion 276 presses down the bound objects 100 such as paper.

The standing portion 270a has an inclined surface (at about 45° relative to the vertical plane) so that the gap between itself and the bearing plate 224 becomes wider upwards to secure space for releasing the operation lever 260 from the retainer projection 228.

The other end 250c of the spring member 250 has a shape similar to the inner surface of the binding member 270, and it is set on the inner side of the binding member 270 such that the upright portion 250d of the spring member 250 is arranged near the inner surface of the standing portion 270a of the binding member 270, and the bridge portion 250e of the spring member 250 is arranged near the inner surface of the bridge portion 270b of the binding member 270.

The turned portion 274 is formed with a rectangular through hole 278, and the other end 250c of the spring member 250 is fitted therein from the side of the bridge portion 270b, the distal end (engaging portion 250f) of the other end 250c of the spring member 250 being bent so that it does not come off of the through hole 278.

In this embodiment, the through hole 278 is formed at a position closer to the coil part 250a coiled around the shaft 246, between the protruding pieces 272 at the front and rear ends of the binding member 270.

Further, the pressing portion 276 includes a linear rib 280 to prevent deformation caused by the force applied to press down the bound objects 100 such as paper.

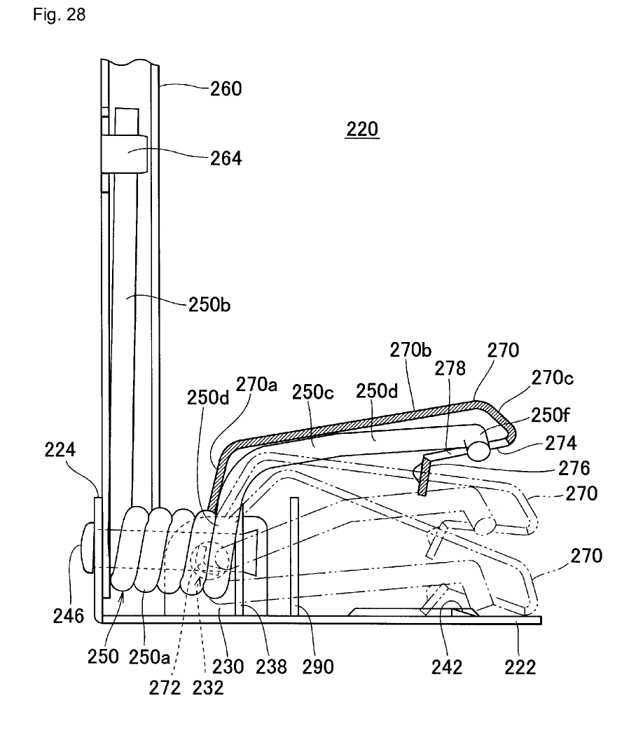

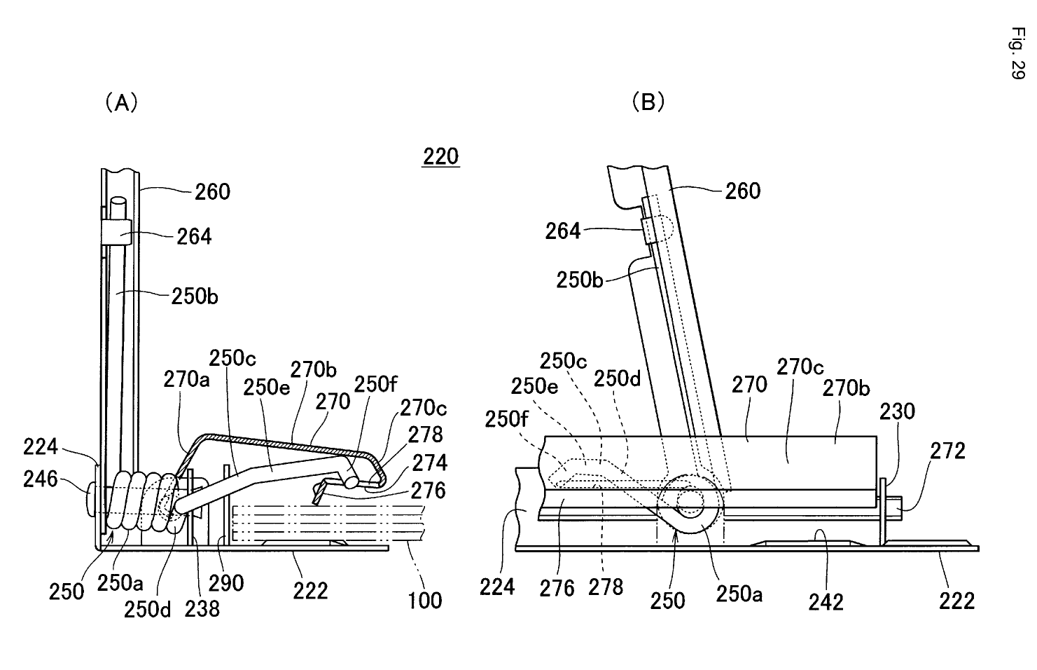

The distal end (engaging portion 250f) of the spring member 250 remains substantially in the same position in the widthwise direction of the board 222 whether the binding member 270 is closed or opened as shown in FIG. 28.

When the operation lever 260 is locked in the retainer projection 228, with the binding member 270 pressing down the bound objects 100 such as paper, the other end 250c of the spring member 250, which is initially bent, is stretched, as well as the distal end (engaging portion 250f) is twisted so that the engaging portion 250f is deformed downwards from its initial horizontal position. The through hole 278 extends along the length and the width of the turned portion 274 so as to allow this deformation of the spring member 250.

The board 222 includes a paper jogging part 290 for jogging the side edges of the objects 100 to be bound such as paper, the jogging part being formed on the side outer than the protruding pieces 272 from the turned-up part 234 and having a surface that is parallel to the surface of the bearing plate 224.

The paper jogging part 290, too, is provided by forming a U-shape cut in the board 222 and turning up this part.

Note, the turned-up part 234 is formed such that its side edge opposite from the bearing plate 224 is aligned with the (imaginary) plane that coincides with the surface of the paper jogging part 290 on the opposite side from the bearing plate 224.

Therefore, the side edge of the turned-up part 234 serves as a guide, on which the side edges of the objects 100 to be bound such as paper are abutted when binding them.

This binding device 220 is attached to a file or the like using, for example, fixture metal parts inserted in the through holes 244 in the board 222.

The binding member 270 is opened and closed by operating the operation lever 260.

Referring now to FIG. 22, when the operation lever 260 is turned up, the other end 250c of the spring member 250 lifts up the binding member 270, creating a gap between the board 222 and the pressing portion 276 of the binding member 270.

Objects to be bound 100 such as paper are inserted in this gap, and the operation lever 260 is turned down to close the binding member 270 so that the bound objects 100 such as paper are pressed down onto the board 222 with the pressing portion 276.

That is, turning down the operation lever 260 tightens up the coil 250a of the spring member 250, whereby the other end 250c of the spring member 250 biases the pressing portion 276 toward the board 222.

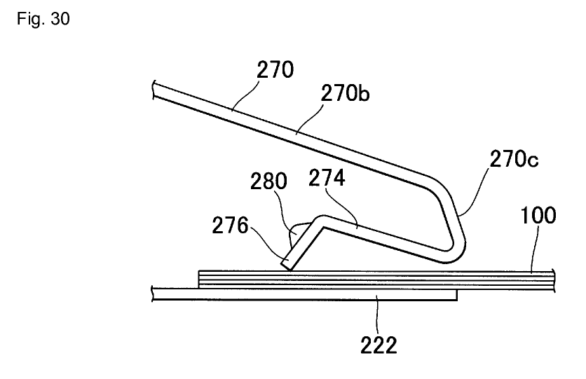

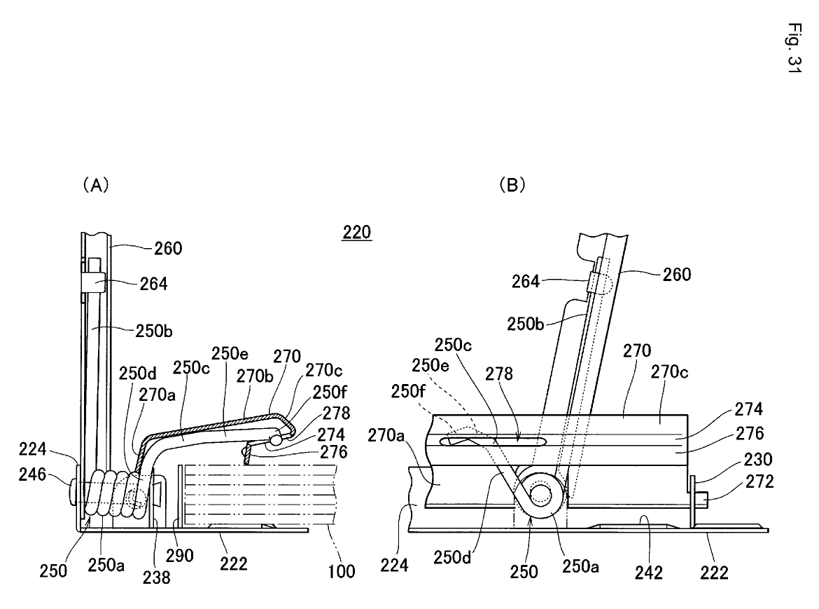

Here, as shown in FIG. 29 and FIG. 30, the pressing portion 276 is pressed diagonally against the bound objects 100 such as paper.

When a force is applied that causes the bound objects 100 such as paper to be pulled out, there will be a force applied oppositely from the inclined direction of the pressing portion 276 as well as a force that causes the bent portion of the turned portion 274 and the pressing portion 276 to bend further.

The restoring force caused by the deformation of the turned portion 274 and the pressing portion 276 creates a resisting force against the pulling-out of the bound objects 100 such as paper from the pressing portion 276, whereby the bound objects 100 such as paper will be hard to come off of the binding device 220.

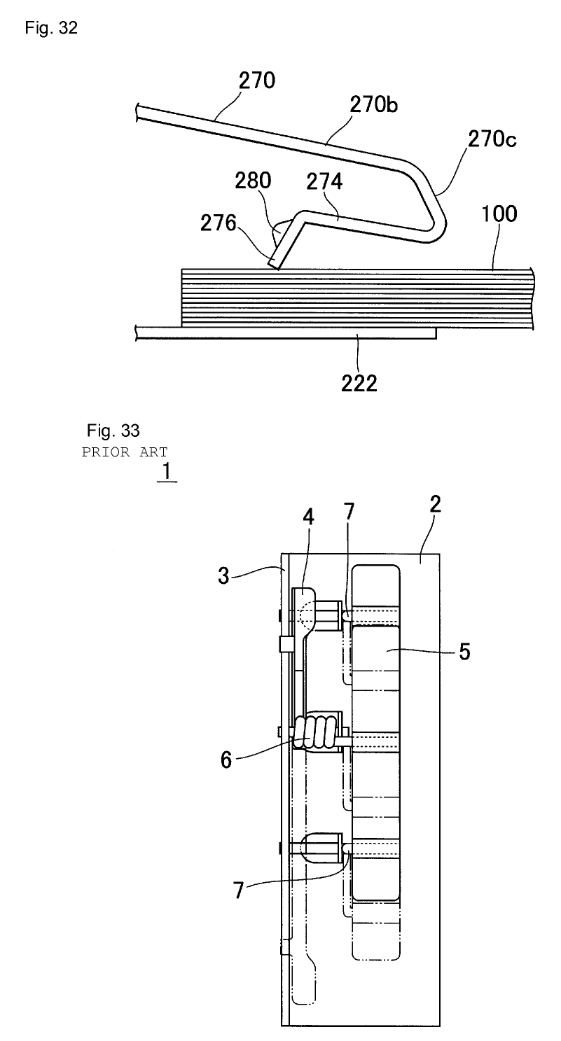

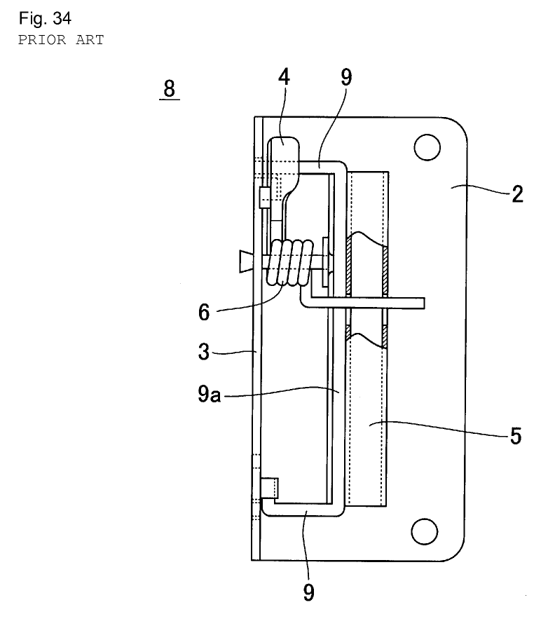

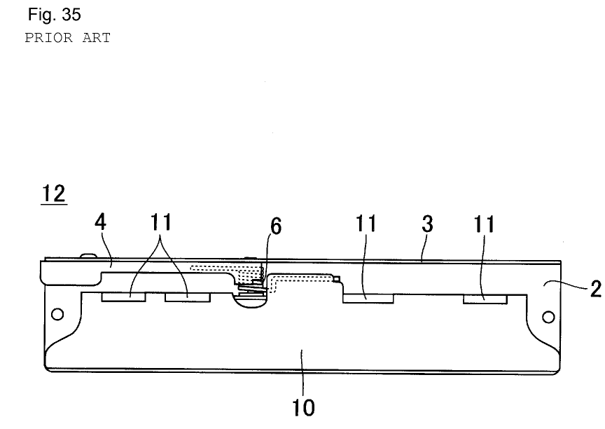

Moreover, because the pressing portion 276 is inclined toward the rotation center of the binding member 270 from the turned portion 274 to the board 222, as shown in FIG. 31 and FIG. 32, when the bound objects 100 such as paper are thick, the pressing portion 276, while it is more upright than when the objects 100 are thin, hardly comes to a position orthogonal to the surface of the bound objects 100 such as paper, so that the resisting force against the coming-off of the bound objects 100 such as paper is well retained.

1-7. (canceled)

8: A binding device comprising:
a plate-like board;
an operation lever rotatably supported on the board;
at least a one-piece binding member including a pressing portion at a distal end thereof to press down and hold objects to be bound on the board; and
a spring member coupled to the operation lever and to a distal end of the binding member so as to apply a pressure to the distal end of the binding member when the operation lever is operated; wherein
the binding member is rotatable around an axis at an opposite side from the pressing portion when the operation lever is operated and includes a distal end of the pressing portion that is bent towards the rotation center of the binding member.

9: The binding device according to claim 8, wherein the binding member is made of a single plate material, and a distal end of the plate material defines the pressing portion such that the objects to be bound are pressed down along a straight line or at a plurality of positions along a straight line.

10: The binding device according to claim 8, wherein the pressing portion is defined by the distal end of the binding member made of the plate material that is bent towards the rotation center of the binding member.

11: The binding device according to claim 9, wherein the pressing portion is defined by a portion of the distal end of the binding member made of the plate material bent towards the rotation center of the binding member and another portion of the distal end bent toward the board side.

12: The binding device according to claim 9, wherein a rotation center of the binding member is defined by providing protruding pieces projecting from both ends of the binding member and inserting the protruding pieces into through holes provided in turned-up parts provided in the board.

13: The binding device according to claim 8, wherein rotation axes of the operation lever and the binding member are substantially perpendicular to each other.

14: The binding device according to claim 8, wherein rotation axes of the operation lever and the binding member are substantially parallel to each other.
